(19) United States
(12) Patent Application Publication
(10) Pub. No.: US 2026/0108997 A1
(43) Pub. Date: Apr. 23, 2026

(54) METHOD FOR REDUCING RESIDUAL UNBALANCE OF A MACHINING SPINDLE

(71) Applicant: ETA SA Manufacture Horlogère Suisse, Grenchen (CH)

(72) Inventors: Patric PHAM, Utzenstorf (CH); Christophe Donzé, Pieterlen (CH); Joël Röthlisberger, Grenchen (CH); Noé Jäggi, Lignières (CH)

(73) Assignee: ETA SA Manufacture Horlogère Suisse, Grenchen (CH)

(21) Appl. No.: 19/329,677

(22) Filed: Sep. 16, 2025

(30) Foreign Application Priority Data
Oct. 22, 2024 (EP) 24207965.5

(51) Int. Cl. B23Q 15/12

(52) U.S. Cl. CPC B23Q 15/12

(57) ABSTRACT

A method for reducing residual unbalance of a spindle (10) in a numerically controlled machine tool, the spindle (10) being designed to hold a tool (20) fastened to it by a tool holder. The method includes a data acquisition phase in which at least two measurement operations are carried out; the spindle (10) and the tool (20) are arranged at different angles relative to each other, and in each of which the spindle (10) is rotated and the vibrations to which the spindle (10) is subjected are measured and recorded in a database. The target angular position of the spindle (10) relative to the tool (20) is determined from the database compiled from the measurements and the spindle (10) and the tool (20) are oriented relative to each other according to the target angular value.

### CROSS REFERENCE TO RELATED APPLICATIONS

This application claims priority to European Patent Application No. 24207965.5 filed Oct. 22, 2024, the entire contents of which are incorporated herein by reference.

### TECHNICAL FIELD OF THE INVENTION

The invention relates to the field of machine tools, in particular numerically controlled machine tools.

More specifically, the invention relates to a method for reducing residual unbalance of a machining spindle.

### TECHNOLOGICAL BACKGROUND

To machine a part, particularly by milling, numerically controlled machine tools (NCMTs) have a spindle, which is a shaft that is rotationally mobile relative to a frame by means of bearings and is designed to accommodate a tool holder in which a tool is secured. When rotated, the spindle transmits the rotational movement to the tool to machine a part.

Machining a complete part usually requires several tools with different shapes and/or dimensions. NCMTs can therefore have a tool magazine in which all the tools and tool holders required to produce a complete part are stored. The tools are taken from the tool magazine and fitted on the spindle by a manipulator arm, which is also capable of removing a tool from the spindle and putting it in the tool magazine.

In practice, the tools are manually fitted in their tool holders by an operator outside the machine, for example at a workbench. Once the tool is secured to the tool holder, the operator manually inserts the tool holder into a slot in the tool magazine on the NCMT. These manual operations performed by the operator can result in an unbalanced assembly and consequently lead to spindle unbalance during rotation.

Moreover, uncertainties about the rotational equilibrium of the tool, tool holder and spindle assembly can arise from the assembly of the components of the spindle and bearings by means of which the spindle is attached so as to be rotationally mobile relative to the NCMT frame. Similarly, tools and tool holders can be out of balance.

Furthermore, the use of asymmetric tools is particularly challenging due to their design. This is because the centre of inertia of these tools is not on their axis of rotation due to their asymmetry, which leads to unbalance.

To sum up, there are a significant number of factors that can cause unbalance during spindle rotation, and as a result, residual unbalance is practically systematic.

The present invention provides a solution for reducing the unbalance of the spindle in an NCMT.

### SUMMARY OF THE INVENTION

To this end, the invention relates to a method for reducing residual unbalance of a spindle in a numerically controlled machine tool, said spindle being designed to hold a tool fastened to it by a tool holder. It should be noted that, in this specification, the assembly formed by the tool and the tool holder is referred to by the generic term “tool” insofar as, throughout the entire use of the method according to the invention, the tool and the tool holder are not disassembled and thus remain in their positions relative to each other.

The method according to the invention comprises a data acquisition phase in which at least two measurement operations are carried out, in each of which the spindle and the tool are arranged relative to each other at different angles. Moreover, in each of these operations, the spindle is rotated, at a speed greater than 10 krpm, for example, and the vibrations to which the spindle is subjected are measured and recorded in a database as a value V₀, . . . , Vₙ representative of their intensity. Each of the V₀, . . . , Vₙ values is associated with an angular value θ₀, . . . , θₙ representing the angle formed between the spindle and the tool during the measurement.

The method also comprises a step in which a target angular position of the spindle relative to the tool is determined from the database compiled from the measurements, the target angular position having a target angular value θₓ corresponding to the angular value θ₀, . . . θₙ associated with the minimum V₀, . . . . Vₙ value.

A positioning step in which the spindle and the tool are oriented relative to each other according to the target angular value ex.

In particular embodiments, the invention can further comprise one or more of the following features, taken separately or in any technically possible combination.

In particular embodiments, the data acquisition phase is implemented such that at least three measurement operations are carried out, and in which the spindle and the tool are arranged relative to each other such that the angular values θ₀, . . . , θₙ correspond to angles evenly distributed or randomly distributed over a range of 360 degrees, with θ₀=0 degrees and θₙ≤360 degrees.

In particular embodiments, the vibrations to which the spindle is subjected are measured by an accelerometer sensor, each of the V₀, . . . , Vₙ values corresponding to a displacement, a displacement velocity or an acceleration of a point on the tool when the spindle is rotating.

In particular embodiments, in the data acquisition phase, between two successive measurements, the spindle is immobilised, the tool is detached from the spindle by a manipulator arm, the spindle is pivoted by an angle corresponding to the difference between two successive angular values θ₀, . . . , θₙ, then the tool is engaged in the spindle in an angular position identical to the one it was in when it was detached, according to a reference system linked to a frame of the numerically controlled machine tool.

In particular embodiments, the data acquisition phase and the determination step are carried out on a plurality of tools, for each of which an individual target angle value θₓ is saved to the memory.

### BRIEF DESCRIPTION OF THE FIGURES

Other features and advantages of the invention will become apparent from the following detailed description, given by way of non-limiting example, with reference to the attached drawings in which:

FIGS. 1a to 1f schematically show a cross-sectional view of a spindle in which a tool is engaged, the spindle and the tool being arranged at different angles relative to each other in each of said figures, for the implementation of a data acquisition step in a method for reducing residual unbalance of a spindle in a numerically controlled machine tool;

FIG. 2 shows a table of the data measured in the data acquisition step;

FIG. 3 shows a radar chart of the data in the table in FIG. 2.

It should be noted that the figures are not necessarily drawn to scale for clarity reasons.

### DETAILED DESCRIPTION OF THE INVENTION

The present invention relates to a method for reducing residual unbalance of a spindle 10 in a numerically controlled machine tool, referred to hereinafter as an “NCMT.” As is known per se, the spindle 10 is designed to hold a tool 20 fastened to it by a tool holder (not shown in the figures) so as to carry out machining operations, for example. Such a tool 20 extends along a longitudinal axis and is formed, for example, by a milling cutter. In this specification, the assembly formed by the tool 20 and the tool holder is referred to simply as the “tool” for the sake of simplicity.

The method according to the invention comprises several phases, including a first data acquisition phase, in which at least two measurement operations are carried out. In an exemplary embodiment of the invention shown in the figures, six measurement operations are carried out.

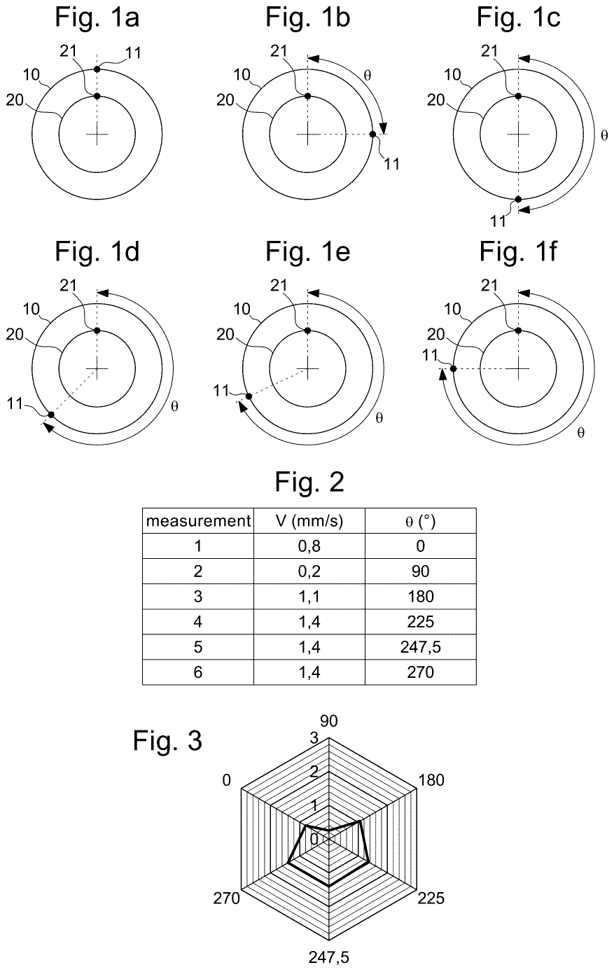

In each measurement operation, the spindle 10 and the tool 20 are arranged at different angles relative to each other. It is clear that the angle in question has its origin at the longitudinal axis of the tool 20 and extends in a plane perpendicular to this longitudinal axis. In other words, taking a fixed point 21 on the tool 20 and a fixed point 11 on the spindle 10, as shown schematically in FIGS. 1a to 1f, in each measurement operation, the tool 20 is fitted in the spindle 10 such that the respective points on the tool 20 and on the spindle 10 form a different angle relative to each other.

In each of the measurement operations, the spindle 10 is preferentially rotated at a speed greater than 10 krpm or even at a speed equal to 30 krpm or to 60 krpm, then the vibrations to which the spindle 10 is subjected are measured and recorded in a database. These vibrations characterise the unbalance of the spindle 10. More specifically, as shown in the table in FIG. 2, the vibrations are recorded as a value V₀, . . . , Vₙ representing their intensity, each of the V₀, . . . , Vₙ values being associated with an angular value θ₀, . . . , θₙ representing the angle formed between the spindle 10 and the tool 20 during the measurement operation in which the vibration intensity is recorded. The data in FIG. 2 are shown on the radar chart in FIG. 3.

In the method according to the invention, vibrations can be measured by any measuring organ capable of evaluating a physical quantity, such as an accelerometer sensor, an optical sensor, an inductive sensor, a capacitive sensor, an extensometer, a microphone, etc. Preferably, an accelerometer sensor is used to perform measurements during the measurement operations. The V₀, . . . , Vₙ values are therefore expressed in mm/s in the table in FIG. 2. Alternatively, the V₀, . . . , Vₙ values can be expressed in any appropriate dimensions, depending on the measuring organ used, for example in terms of acceleration (mm/s²) or of displacement (mm).

In the exemplary embodiment of the present invention described herein, to change the relative angular value θ₀, . . . , θₙ between the spindle 10 and the tool 20 between two successive measurement operations, only the spindle 10 is pivoted, while the tool 20 remains in a fixed angular position. More specifically, when a measurement operation has been completed, before starting the next measurement operation, the tool 20 is removed from the spindle 10 by a manipulator arm, in a manner known per se to a person skilled in the art, and the spindle 10 is pivoted by a predetermined angle to reach the angular value θ₀, . . . , On provided for said subsequent measurement operation. The tool 20 is then engaged in the spindle 10 by the manipulator arm, in the same orientation as it was in when it was removed, according to a reference system linked to a frame of the NCMT.

The angular values θ₀, . . . , θₙ thus correspond to specific angular positions of the spindle 10 in the preferred embodiment of the invention. Alternatively, it can be foreseen to pivot only the tool 20 after it has been removed from the spindle 10, or to pivot both the tool 20 and the spindle 10, so that they have an angular value θ₀, . . . , On relative to each other.

It should be noted that the angular values θ₀, . . . , θₙ are predefined, with their step, in other words the distance between two chosen angular values in two successive measurement operations, depending on the desired resolution of the vibration measurements. As shown in the table in FIG. 2 and in the graph in FIG. 3, the angular values θ₀, . . . , θₙ between two successive measurement operations can be 90°, 45°, 22.5° or any other angle comprised between 0° and 360°. The pitch may or may not be the same between all of the measurements taken.

The method then comprises a step in which a target angular position of the spindle 10 relative to the tool 20 is determined, the target angular position having a target angular value θₓ corresponding to the angular value θ₀, . . . θₙ associated with the minimum V₀, . . . . Vₙ value in the database compiled from the measurements taken. In other words, the V₀, . . . , Vₙ values are compared to identify the minimum value and then the angular value θ₀, . . . , On associated with the minimum vibration intensity value is selected. This selected angular value represents the target value θₓ.

In the example shown in the table in FIG. 2 and in the graph in FIG. 3, the minimum vibration intensity value was measured during the second measurement and corresponds to 0.2 mm/s at an angular value of 90°. The target angular position ex is therefore equal to 90°. The target angular value θₓ is particularly noticeable in the graph in FIG. 3, where the bolded curve representing the value V₀, . . . , Vₙ has an inflection point coinciding with a segment representing 90°.

This step is preferably carried out by an IT processing unit on the NCMT. Such a processing unit, for example consisting of a microcontroller or microprocessor, and its interactions with the various organs in the NCMT are known to a person skilled in the art and are therefore not described in detail in this specification.

Afterwards, in a positioning step, the spindle 10 and the tool 20 are oriented relative to each other according to the target angular value θₓ. Preferably, the manipulator arm removes the tool 20 from the spindle 10, which is then oriented so as to be in an angular position corresponding to the target angular value θₓ. The tool 20 is then engaged by the manipulator arm in the spindle 10 and is ready for use in machining operations.

In general, the spindle 10 and the manipulator arm are displaced by electric motors controlled by control signals generated by the processing unit in a manner known to a person skilled in the art.

The method according to the invention can be advantageously implemented by a machining centre comprising a tool magazine, the manipulator arm and the NCMT.

In particular, the tool magazine can comprise a plurality of tools, each with its own target angle value θₓ stored in the memory. Thus, before loading a tool onto the spindle 10 in order to perform a specific machining operation, the spindle 10 is oriented so as to be in an angular position relative to the tool it is going to hold, such that the unbalance of said spindle 10 fitted with said tool is minimised.

To sum up, the method according to the invention must be implemented as soon as a new tool is added to the tool magazine, so that the target angle value θₓ to be applied to the spindle 10 is recorded before the corresponding tool is loaded.

Advantageously, the method according to the invention does not need to be implemented each time a tool is to be used, provided that the corresponding target angle value θₓ has been saved. Nevertheless, to ensure that the vibration level of the spindle 10 always corresponds to the optimised equilibration values previously measured, the method according to the invention can be repeated after a predefined period of use of the tool 20, for example.

More generally, it should be noted that the embodiments and uses considered above have been described by way of non-limiting examples, and that other variants are therefore conceivable.

1. A method for reducing residual unbalance of a spindle (10) in a numerically controlled machine tool, the spindle (10) being designed to hold a tool (20) fastened to it by a tool holder, the method comprising:
a data acquisition phase in which at least two measurement operations are carried out; in each of the measurement operations, the spindle (10) and the tool (20) are arranged at different angles relative to each other, and in each of which the spindle (10) is rotated and the vibrations to which the spindle (10) is subjected are measured and recorded in a database as a value V₀, . . . , Vₙ representative of their intensity, each of the V₀, . . . , Vₙ values being associated with an angular value θ₀, . . . , θₙ representative of the angle formed between the spindle (10) and the tool (20) during the measurement,
a step in which a target angular position of the spindle (10) relative to the tool (20) is determined from the database compiled from the measurements, the target angular position having a target angular value θₓ corresponding to the angular value θ₀, . . . θₙ associated with the minimum V₀, . . . Vₙ value,
a positioning step in which the spindle (10) and the tool (20) are oriented relative to each other according to the target angular value θₓ.

2. The method according to claim 1, wherein the data acquisition phase is implemented such that at least three measurement operations are carried out, and wherein the spindle (10) and the tool (20) are arranged relative to each other such that the angular values θ₀, . . . , θₙ correspond to angles evenly distributed over a range of 360 degrees, with θ₀=0 degrees and θₙ≤360 degrees.

3. The method according to claim 1, wherein the data acquisition phase is implemented such that at least three measurement operations are carried out, and wherein the spindle (10) and the tool (20) are arranged relative to each other such that the angular values θ₀, . . . , θₙ correspond to angles randomly distributed over a range of 360 degrees, with θ₀=0 degrees and θₙ≤360 degrees.

4. The method according to claim 1, wherein the vibrations to which the spindle (10) is subjected are measured by an accelerometer sensor, each of the V₀, . . . , Vₙ values corresponding to a displacement, a displacement velocity or an acceleration of a point on the tool (20) when the spindle (10) is rotating.

5. The method according to claim 1, wherein, in the data acquisition phase, between two successive measurements, the spindle (10) is immobilised, the tool (20) is detached from the spindle (10) by a manipulator arm, the spindle (10) is pivoted by an angle corresponding to the difference between two successive angular values θ₀, . . . , θₙ, then the tool (20) is engaged in the spindle (10) in an angular position identical to the one it was in when it was detached, according to a reference system linked to a frame of the numerically controlled machine tool.

6. The method according to claim 1, wherein the data acquisition phase and the determination step are carried out on a plurality of tools, for each of which an individual target angle value θₓ is saved to the memory.
